(19) United States
(12) Patent Application Publication
(10) Pub. No.: US 2016/0307598 A1
(43) Pub. Date: Oct. 20, 2016

(54) AUTOMATED EDITING OF VIDEO RECORDINGS IN ORDER TO PRODUCE A SUMMARIZED VIDEO RECORDING

(71) Applicant: Daniel Laurence Ford JOHNS, Melbourne (AU)

(72) Inventor: Daniel Laurence Ford JOHNS, Melbourne (AU)

(21) Appl. No.: 15/099,765

(22) Filed: Apr. 15, 2016

Related U.S. Application Data
(60) Provisional application No. 62/148,646, filed on Apr. 16, 2015.

(51) Int. Cl. G11B 27/031; H04N 5/232; H04N 5/77; H04N 21/8549; H04N 5/91

(52) U.S. Cl. CPC G11B 27/031; H04N 21/8549; H04N 5/91; H04N 5/77; H04N 5/23203

(57) ABSTRACT

One or more video cameras are used in conjunction with one or more data acquisition devices to record video and other data with a relationship to the video, respectively. The video and the other acquired data (such as sensor data) are recorded in such a manner that they are or can be synchronized with sufficient accuracy as to create a useful correlation. The sensor data may be used to identify content of interest within a video recording based upon the sensor data. The video may then be edited so as to provide summarized video content. The various embodiments described below show software and apparatuses that extract content of interest from an original video in order to create a highlights video.

This application claims priority to U.S. 62/148,646, which is incorporated by reference in its entirety.

### FIELD OF THE INVENTION

The present invention relates to video editing and in particular video editing based on data not limited to audio and video data included with a video stream. Specifically, a method and apparatus are disclosed for editing video data based on data that is otherwise acquired, such as sensor data.

### BACKGROUND OF THE INVENTION

In the past, extraction of highlight segments from video recordings was tedious. One or more videos of a scene or a group of scenes were opened, i.e. placed on a timeline, in video editing computer software. Then an operator would edit, i.e. cut, paste, and reorganize segments of the video to form a final video that maximized interest and removed uninteresting or unnecessary material. In addition, sound and various effects such as transitions from one scene to the next, additional dialog among actors, and the like were added to give a video a polished, professional feel. When the editing step was finished, the operator would instruct the software to record and save a final, edited version of a video.

Various methods for editing video information are known. The following is a list of some prior-art methods.

| Pat. or Pub. Nr. | Kind Code | Issue or Pub. Date | Patentee or Applicant |
|---|---|---|---|
| 4,054,752 | | 1977 Oct. 18 | Dennis, Jr. et al. |
| 5,065,251 | | 1991 Nov. 12 | Shuhart, Jr. et al. |
| 6,389,340 | B1 | 2002 May 14 | Rayner |
| 6,449,540 | B1 | 2002 Sep. 10 | Rayner |
| 6,747,690 | B2 | 2004 Jun. 08 | Molgaard |
| 6,795,638 | B1 | 2004 Sep. 21 | Skelley, Jr. |
| 6,856,757 | B2 | 2005 Feb. 15 | Daglas |
| 7,199,798 | B1 | 2007 Apr. 03 | Echigo et al. |
| 7,675,543 | B2 | 2010 Mar. 09 | Jain et al. |
| 7,536,457 | B2 | 2009 May 19 | Miller |
| 7,742,145 | B2 | 2010 Jun. 22 | Krause et al. |
| 7,804,426 | B2 | 2010 Sep. 28 | Etcheson |
| 7,844,163 | B2 | 2010 Nov. 30 | Wakita et al. |
| 8,200,063 | B2 | 2012 Jun. 12 | Chen et al. |
| 8,319,834 | B2 | 2012 Nov. 27 | Jain et al. |
| 8,373,567 | B2 | 2013 Feb. 12 | Denson |
| 2013/0096731 | A1 | 2013 Apr. 18 | Tamari et al. |

Non-patent document: “A Survey on Recent Advances of Computer Vision Algorithms for Egocentric Video”, Sven Bambach, Indiana University, Sep. 8, 2013.

In the above references, Dennis shows a cashier holdup video recording system that produces a recording before, during, and after an event.

Schuhart shows a video recording system that provides a data marker in response to an official's whistle.

In U.S. Pat. No. 6,389,340, Rayner shows a video system with a variety of sensors that respond to event triggers such as a sudden change in acceleration, and store the video at such trigger times. In U.S. Pat. No. 6,449,540, Rayner shows a video system with sensors to detect external wave patterns, light, radio, and sound, as triggers for a video. Otherwise, '540 is similar to '340.

Molgaard shows a digital camera with accelerometers that provide information for correction of a picture.

Skelly shows a two-recorder system. A first video records performance events, and a second video stores a database of defined events during a performance. An operator selects events and these are marked on the first video and extracted to a second video.

Daglas shows a system for detecting sports highlights based on images.

Echigo shows a method and device for describing video contents.

In '543 and '834, Jain shows a system for automatically identifying segments of interest within video footage.

Miller shows a video system with a geographic positioning system (GPS) and an accelerometer as sensors for marking relevant events. The relevant events are sent to a remote server and stored.

Kraus shows a film clip editor.

Etcheson shows a system for selective review of video recordings based on event triggers.

Wakita shows a video marker and editor.

Chen shows a video summarizer.

Denson shows a dashcam (vehicle dashboard-mounted) camera with GPS in a system for gauging driver behavior. The camera includes an automatic editing function to derive an abbreviated set of events. Events are classified as relevant or not-relevant of risky behavior based on a comparison with previous non-relevant events.

Tamari shows a video system with geo-location sensors for triggers (speed, time, location, acceleration) and for an abbreviated record. When an event is detected it is sent to a remote location and stored.

Bambach discusses recent advances to summarize video and the current inaccuracies and work yet to be done.

### SUMMARY OF THE INVENTION

One or more video cameras are used in conjunction with one or more data acquisition devices to record video and other data with a relationship to the video, respectively. The video and the other acquired data (such as sensor data) are recorded in such a manner that they are or can be synchronized with sufficient accuracy as to create a useful correlation. The sensor data may be used to identify content of interest within a video recording based upon the sensor data. The video may then be edited so as to provide summarized video content. The various embodiments described below show software and apparatuses that extract content of interest from an original video in order to create a highlights video.

### BRIEF DESCRIPTION OF THE DRAWINGS

FIG. 1 is a perspective view showing placement of cameras and associated components for recording a vehicle road race activity in accordance with an exemplary embodiment of the present invention.

FIG. 2 is a block diagram showing electronic components and software used in one exemplary embodiment of the present invention.

FIG. 3 shows the mode selection the user makes in one exemplary embodiment of the present invention.

FIG. 4a is a flowchart showing the software processing model used in one exemplary embodiment of the present invention.

FIG. 4b is a continuation of FIG. 4a.

FIG. 5a is a flowchart showing the software processing model used in one exemplary embodiment of the present invention.

FIG. 5b is a continuation of FIG. 5a.

### DETAILED DESCRIPTION

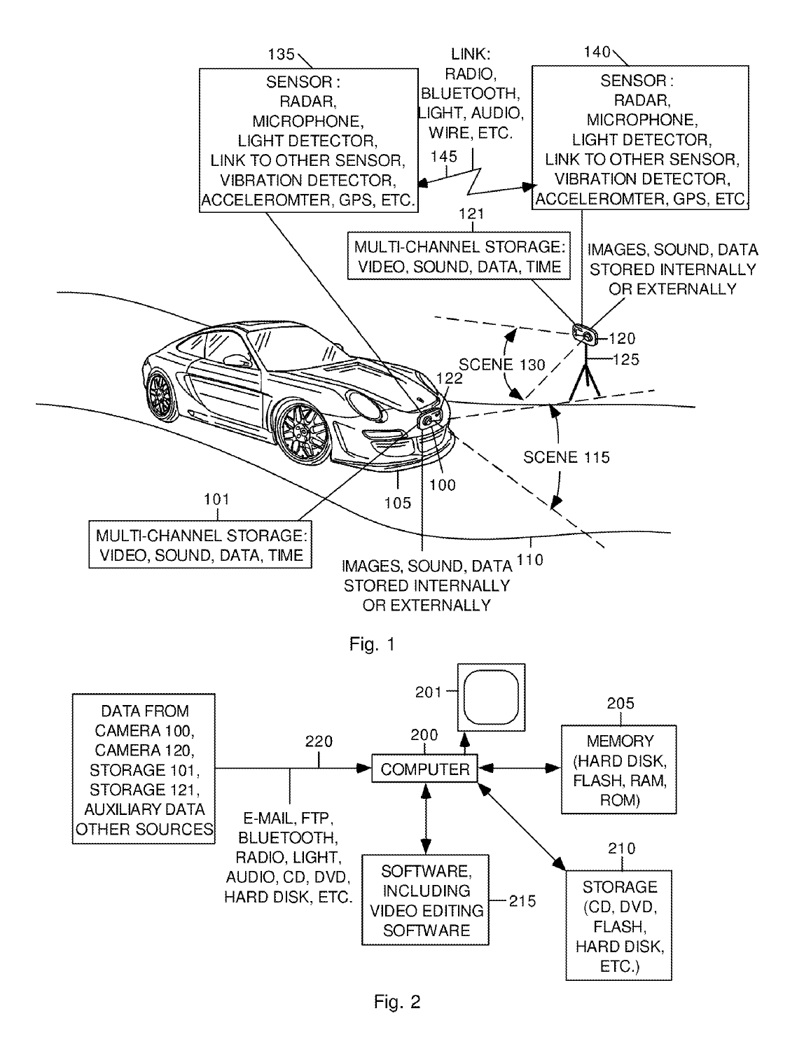

FIG. 1 shows one aspect of an embodiment that includes a first camera 100 mounted on a vehicle 105 that is traveling on a roadway 110. In this example, camera 100 records a scene 115 in front of vehicle 105 that comprises roadway 110 and surroundings. A second camera 120 is mounted on a tripod 125 on roadway 110 and positioned to record a scene 130 that includes vehicle 105, roadway 110, and surroundings. Additional cameras and sensors (not shown) are located at additional sites and record additional events and data. Cameras 100, 120, and any others record events that happen during an activity, such as an auto race that is described below.

Cameras 100 and 120 are video cameras in this example, although they can be still cameras if desired. Cameras 100 and 120 record and store images, sounds, and data on internal media, respectively, such as well-known flash or other solid-state memory. Alternatively, they record images and sounds, and data on external recorders 101 and 121 such as solid-state memory, a hard disk drive, or a tape drive. Recorders 101, 121 and the recorders internal to cameras 100 and 120 are multi-channel devices, i.e. they record video, audio, and at least one form of data such as the speed of vehicle 105, all as a function of time. Time is recorded as time of day or elapsed time. A record button 122 on camera 100 activates camera 100 when pressed by a user.

Sensors 135 and 140 provide at least one type of data selected from sound, light, vibration, acceleration and GPS data to cameras 100 and 120, respectively. Part or all of sensors 135 and 140 are included within cameras 100 and 120, respectively. Alternatively, part or all of each sensor is external to its respective camera.

A link 145 is a wired or wireless communication link incorporating one or more of the following: WiFi (wireless networking technology), Bluetooth networking technology (the Bluetooth mark is owned by the Bluetooth Special Interest Group of Kirkland, Wash.), radio, audio, or light communication protocol. Link 145 synchronizes the functions of cameras 100 and 120 and any other cameras (not shown) that are used in capturing an event for video recording and editing according to the present embodiment.

FIG. 2 shows a computer system for analyzing video information and data that are representative of events during the recordation of a video. A computer 200 with a humanly sensible monitor screen 201 communicates with a memory 205, storage 210, and software 215 in well-known fashion. Software 215 includes video editing software similar to VisualStudio brand, sold by Corel Corporation of Ottawa, Canada, however software 215 further includes data analysis capabilities not heretofore available in video editing software, i.e. the linking of event data with video data in order to automatically extract events from the video data and save the events in the same or a different video computer file. A link 220 communicates data from cameras 100 and 120, storage units 101 and 121, plus data from other sources (not shown) and auxiliary data to computer 200.

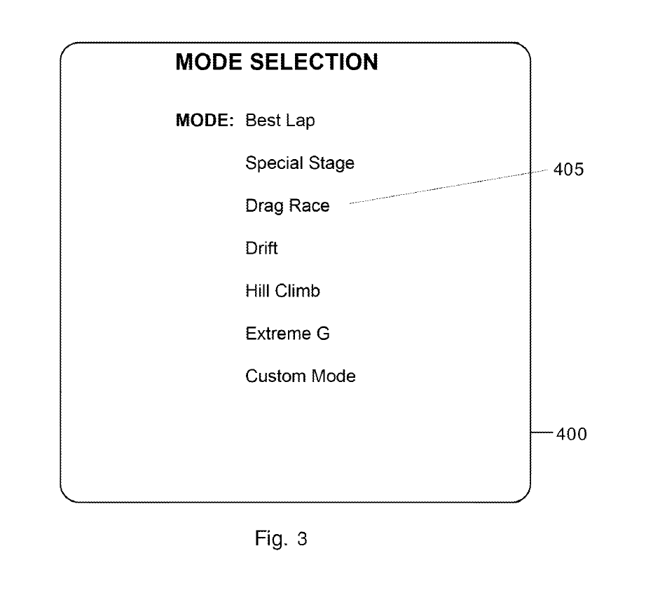

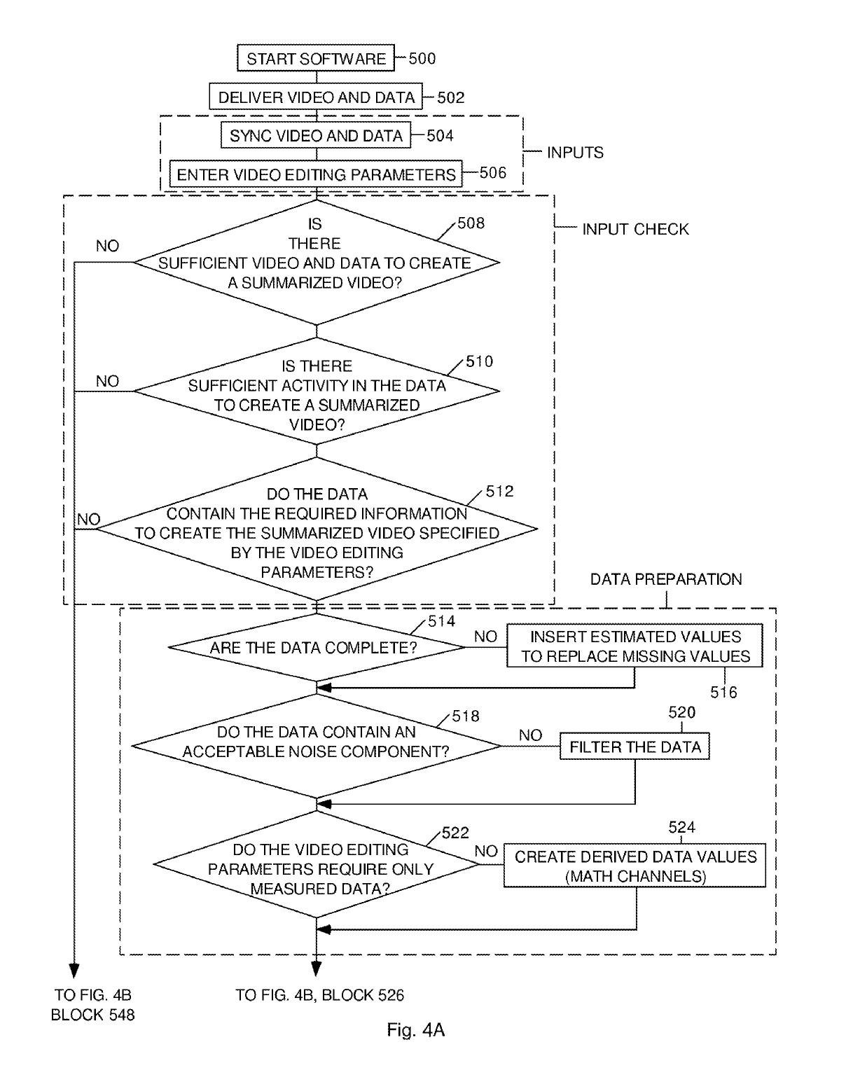

A simple screen is shown to a user. FIG. 3 shows a mode selection setup computer screen 400 that is displayed on monitor 201 (FIG. 2) in which a user enters or selects an activity that will be captured in a final video.

For example, in FIG. 3 a user wishes to capture the best lap performed. Software 215 determines what “best lap” means in its processing. Position sensor 135 installed in vehicle 105 relays values of position to computer 200 as vehicle 105 moves. When the vehicle is no longer in motion the position data channel is used to determine the periodicity of motion of vehicle 105 with respect to spatial coordinates and determine the lap with lowest elapsed time. Software 215 operating in computer 200 then creates a summarized video from the beginning of the lap to the end.

An alternative processing path may be followed by the user configuring a custom summarized video by manually selecting various parameters that software 215 uses to create a video segment. However this processing is not described by this embodiment.

### First Exemplary Embodiment

### A Cross-Country Race Example

In one example, a vehicle 105 is entered into a cross-country race on a roadway 110. A user (not shown) desires to record the vehicle's maximum speed during the race using the radar in sensor 140.

Recording of video and data are started by a user (not shown) at T₁ by activating any of camera 100, camera 120, sensor 135, or sensor 140. Upon activation of any of these components, a link 145 sends a signal to all other components in the system via radio, Bluetooth, light, audio, hard-wire, or another signaling system. T₁ is set at any time before the race begins, at the start of the race, or at any later desired time. The only requirement for starting the recordation of data is that the start of the recording captures a predetermined period of time before a predetermined event in order that the entire event, such as the maximum speed of a vehicle, is captured in the video and the accompanying data.

Recording of video and data are stopped either manually by a user, a timer in one of cameras 100 or 120 or sensors 135 or 140 preset for a predetermined time, or a signal from one of sensors 135 or 140. When the recording of video and data are stopped, link 145 sends a deactivation signal to all components in the system.

In the present example, a user pressed the record button 122 at the start of the race and all components of the system were activated at T₁. Video from cameras 100 and 120 and sensor data from sensors 135 and 140 were recorded on storage units 101 and 121. The speed of vehicle 105 was measured by the radar capability in sensor 140. Instead of radar, a user may choose to use the time derivative of the GPS position of a vehicle as an indication of speed.

After the end of the race, all data stored in storage units 101 and 121 are communicated to computer 200 via link 220. Software 215 in computer 200 causes at least a portion of the data from the race to be entered into 205. In this manner, video streams from one or more cameras are acquired.

It is desirable to show a portion of the video after the maximum speed is reached. An interactive function in software 215, indicated at 400-405 (FIG. 3) permits the user to enter a custom mode to enter the values to be used in selecting the portion of a video to be identified with the event. In the present example, a user has chosen 305 “custom mode” and then “maximum speed” as the event to be saved.

Instead of a single event, i.e. maximum speed, a mode representative of a plurality of events can be selected as video triggers by a user. Best lap, special stage, drag race, or any other kind of mode can be chosen so that a single, summarized video record includes the events of interest.

With the selection of this mode, software 215 copies only the video information within the interval to memory 205 or storage 210 for later viewing. Thus in this example, the system shown in FIG. 1 has recorded video and data and these have been communicated to computer 200 for analysis and excerpting by software 215, then stored either in memory 205 or storage 210 for later viewing.

In another aspect, instead of being started by a user, a first sensor triggers the start of video and data collecting and a second sensor terminates the video and data taking.

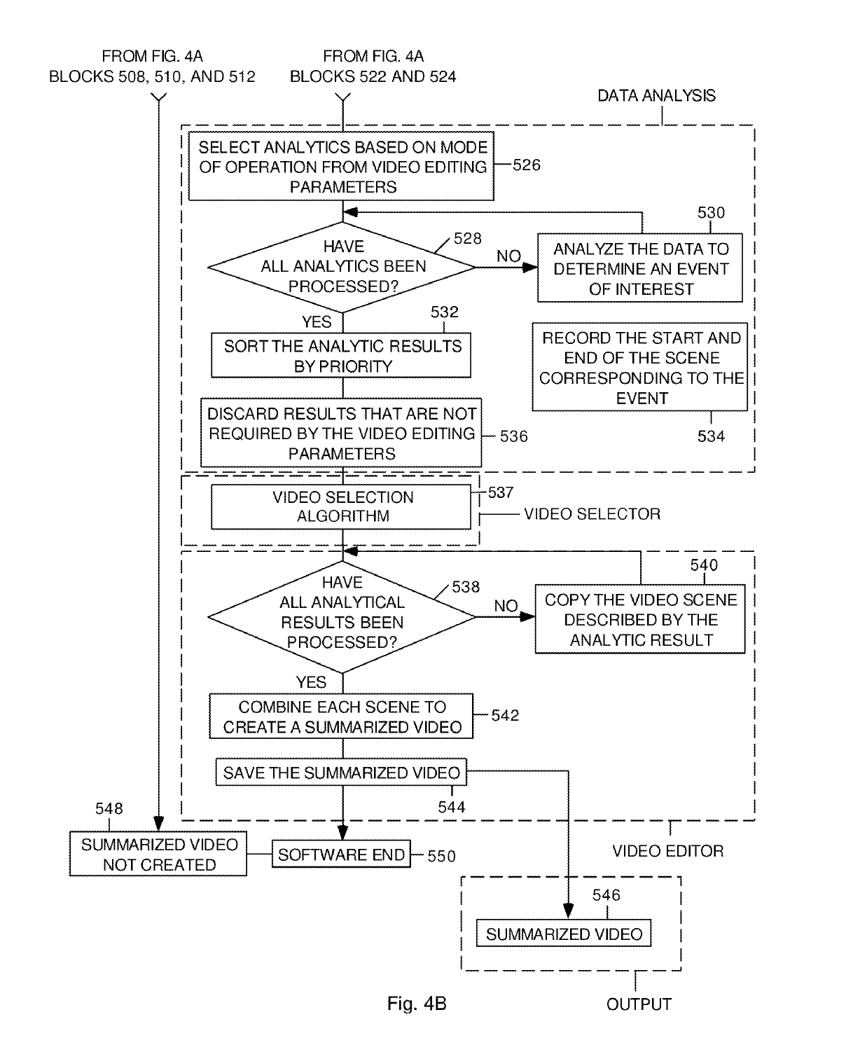

### Flowchart—FIG. 4

At the completion of an activity all video and data recordings are ready for delivery to editing software with data analysis capabilities, as described above. FIG. 4 is a flowchart showing an aspect of the operation of the apparatus and software. At the start (block 500) software 215 is activated in computer 200.

Video and Data Inputs.

One and possibly multiple cameras 100, 120, etc. (FIG. 1) are used to record the video of an activity. The video may or may not have other associated metadata as is common with cameras. Examples of metadata include but are not limited to the time of the recording, length of recording and other associated metadata such as date, time, GPS data, and the like.

At least one and possibly multiple sensors 135, 140, etc. are used to record physical data. As explained above, the sensors that record the data channel may be integrated with the camera or separate from the camera and are not necessarily in the same reference frame of a camera.

The video information and data collected during an activity are delivered to computer 200 via link 220 and stored in memory 205 (block 502). In this manner, sensor dta is acquired from one or more sensors while the video streams are being acquired.

The video recording and data recording are synchronized as described above (block 504). This synchronization may occur by embedding data in the video, embedding video into the data, by using timestamps or some other method. The synchronization need not be exact but has a sufficient accuracy as to create a useful correlation between the video and data. For example if used for a motor sport application the synchronization may only require an accuracy within +/−100 milliseconds however if used for a wind surfing application the synchronization may only require an accuracy within +/−1 second.

Video Editing Parameters.

Next, the video editing parameters are entered into software 215 (block 506). In this manner, one or more video editing parameters are received. The video editing parameters describe how the video is to be summarized. The video editing parameters in an embodiment include a description of (1) scene climax, in this case the maximum speed of vehicle 105 during the race, (2) scene start parameter (3) scene end parameter. The scene climax describes what the user finds as interesting content within the video. The scene climax may be automatically set for an activity or manually set by a user. Each scene climax also includes the required data channels and a display priority.

One example of a scene climax is “maximum speed”. “Maximum speed” means that the user is interested in the point in the video at which the speed as measured by the data sensor is at its maximum. A required data channel for the “maximum speed” scene climax is speed. That is to say that a data channel measuring speed must be available for the scene climax. Note that the required data channel may be measured directly by the sensor or calculated later as described below in connection with block 524. For example the speed data channel required by the “maximum speed” scene climax may be measured directly or calculated by the derivative of change of position with respect to change in time.

Depending on the mode the video editing parameters may include one or many scene climaxes. The processing for the scene climax is described by the analytics in connection with block 528. The scene start parameter describes when the extracted video scene should begin prior to the scene climax. The start may be a time requirement or a data requirement. If the scene start is a data requirement then it also includes the required data channels for its calculation.

An example of a time requirement is a specific number of seconds and fractions thereof before the scene climax occurs.

A data requirement is dependent upon the type of scene climax. In the case of the “maximum speed” example a data requirement may be to start the scene from the point in the video that the body in motion begins to positively accelerate in the longitudinal direction. In this example the required data channel would be longitudinal acceleration. Like the scene climax the required data channel may be measured directly by the sensor or calculated later as described in connection with block 524.

The scene end parameter describes when the extracted video scene should end after the scene climax. This parameter is similar to the scene start parameter and similarly may be either a time or data requirement. If the scene end is a data requirement then it also includes the required data channels for its calculation.

When combined, the scene start and scene end parameters describe the duration of a single scene that encompasses the scene climax. There may be one scene start and one scene end for each scene climax, or scene start and/or scene ends may be shared between multiple scene climaxes.

The video editing parameters may also include other additional descriptions. For example (1) a minimum video duration threshold below which a summarized video should not be created (2) a minimum video activity threshold below which a summarized video should not be created (3) a preferred language to display text on the video (4) preferred units of measurement to display measured data on the video (5) data filter types and parameters to filter the measured data and (6) a maximum highlights video length (7) a maximum number of scenes for the highlights video and (8) other possible parameters.

The above description includes an explanation of the receipt of one or more video editing parameters. One method of entry is via manual entry via a user of hardware, software, or a combination thereof that is being used for editing. Another method of entry is via an automated form of entry, such as via software. Additional automated forms of entry, such as algorithms for generating and/or retrieving video editing parameters may be used, and are described in further exemplary embodiments described below.

Input Check (Blocks 508-512).

Once the video editing parameters are entered, software 215 proceeds to check the quality of the video and data (blocks 508-512). The input check is a software module comprising blocks 508-512 within software 215 that is used in this embodiment to improve the quality of the video processing. The input check may be performed in any order and one or all of the processing steps may not be used. An input test is not a requirement to produce the highlights video but is used to improve the quality of the software program outputs.

Time Check (Block 508).

The Input Check module of the software program checks the duration of the video (block 508). The time check is used to determine if sufficient video content exists to extract video highlights. For example if a video lasts only a few seconds in total duration then the creation of a highlights video may not be meaningful. The time check may be performed by either inspecting the duration of the video or the data. If the video duration is below a predetermined threshold then processing proceeds to block 548. Otherwise the processing continues to block 510.

Activity Check (Block 510).

The Input Check module of the software program checks the level of activity on of the video (block 510). The activity check is used to determine if sufficient activity exists to extract video highlights. For example consider an application that is interested in “maximum speed”. The video duration may be many hours however vehicle 105 being measured may not have moved. In this case no maximum speed events will have occurred in which case the creation of a highlights video may not be meaningful. The activity check is performed by inspecting the data such as speed data or the video information to see if vehicle 105 has moved. If the video activity is below a predetermined threshold then processing proceeds to block 548. Otherwise the processing continues to the next step in block 512.

Required Information Check (Block 512).

The Input Check module of the software program checks the data channels (block 512). The data channel check is used to determine if the required data channels are present to create the desired highlights video. The data channels required may be required directly for processing in block 528 or required for the creation of math channels in block 524 that is subsequently used in block 528.

If the required data channels do not exist then processing proceeds to block 548. Otherwise the processing continues to block 514. In this event an alternative processing path may be followed by the software program automatically determining the activity of interest on behalf of the user by assessing the data channels available. However this processing is not described by this embodiment.

Data Preparation (Blocks 514-524).

The data preparation software module within software 215 is used in this embodiment to improve the quality of the video processing. The data preparation may be performed in a different order and one or all of the processing steps may not be used. Data preparation is not a requirement to produce the highlights video but is used to improve the quality of the software program outputs.

Are the Data Complete? (Blocks 514-516).

The software program checks each data channel for completeness (block 514). For example if the data sampling rate is 1 Hz a data sample is expected each 1 second for the duration of the recording. Depending on the sensor location and source some values may be missing. If one or more values are missing processing continues to block 516, otherwise processing continues to block 518.

Insert Estimated Values to Replace Missing Values (Block 516).

Block 516 of the data preparation is called if values are missing from the data. Software 215 will insert missing values to enable the data to be used to create a highlights video. Software 215 may use linear or non-linear estimates to insert missing values. An example of a linear estimate is to use linear regression to calculate the likely value using surrounding values. An example of a non-linear estimate is to use a quadratic estimation function. The selection of the function is dependent upon the data channel which contains missing values and the most recent measurements for that channel. For example an altitude meter used to measure the change in altitude of a sky diver would use a linear estimator if the sky diver had reached terminal velocity prior to the missing data points and would use a non-linear estimator if the sky diver was still accelerating prior to the missing data points.

Does the Data Contain an Acceptable Noise Level? (Blocks 518-520).

It is well known that data sensor measurements contain an undesired component described as noise. Software 215 may choose to filter the measurements of one or more data channels regardless of the noise level or else estimate the noise within the signal to determine if the noise will affect the quality of the software processing.

An estimation of the noise level can be made using statistical techniques known in the art (block 518). If software 215 determines that one or more data channels should be filtered then processing continues to block 520 for the selected data channels. Otherwise processing continues to block 522.

Filter the Data (Block 520).

Block 520 of the processing is called if block 518 determines one or more data channels should be filtered.

Filtering can be performed using well-known filtering techniques. An example includes a moving average window filter with a predetermined window size. In some aspects it may be preferential to filter data after derived data channels (math channels, described below) have been calculated.

Do the Video Editing Parameters Require Measured Data Only? (Blocks 522-524).

Data channels may be measured or they can be derived from measured channels (block 522). The software program inspects the video editing parameters to determine if measured channels are sufficient or if derived data channels, known as math channels, must be calculated.

If the software program determines that one or more math channels should be created then processing continues to block 524. Otherwise processing continues to block 526.

Create Derived Data Channels (Math Channels) (Block 524)

The software program uses the data channels with mathematical functions described in software to create the required math channels (block 524).

An example of a data channel is GPS position. An example of a math channel is speed calculated from the derivative of position with respect to time. Yet another math channel may be created by deriving other math channels. For example the speed math channel created in the aforementioned example may be derived with respect to time to calculate an acceleration math channel.

In this embodiment the result of creating the math channels are stored with the data channels such that for each sample time the data contains both the corresponding data channels and math channels. In other embodiments the math channels may be stored separate of data channels.

Data Analysis (Blocks 526-536).

The data analysis module, comprising blocks 526-536 of software 215, analyzes the data using discrete modules called analytics. In this embodiment each analytic performs a task of identifying events of interest specific to a single scene climax. Each scene climax corresponds exactly to one analytic and each analytic exactly to one scene climax. This method is used to make the software program more modular and flexible. However in other embodiments the analytics may be combined in any combination to identify scene climaxes. The management of analytics is handled by a software module termed the analytics manager. The description below details the function of the analytics manager and analytics in discovering events of interest within the data.

Select Analytic Based on Mode of Operation from Video Editing Parameters (Block 526).

An analytics manager selects the analytics to run. The selection of analytics is determined by the video editing parameters and may be a result of an activity type, automated selection based on data channels or a manual selection by a system user.

Have all the Analytics been Processed? (Block 528).

From the selected analytics the analytics manager determines if all the analytics have been processed (block 528). Upon first entry of this module the typical result of this test will be that there are analytics remaining to be run. If this is the case then processing continues to block 530. When all analytics have been processed the software continues to block 532.

Analyze the Data to Determine an Event of Interest (Block 530).

The analytics process the data and/or math channels to determine where an event of interest occurs (block 530). Some examples of analytics types are described below. These analytics types are independent of specific channels and may be applied to any data or math channels.

(1) Best Of. This analytic type selects the maximum value found within a data or math channel. For example “maximum speed” or “maximum acceleration” is an example of a “best of” analytic. The Best Of analytic type returns only one scene however it may be combined with other Best Of events by the analytic manager to create multiple scenes for the highlights video. For example best of speed, best of positive longitudinal acceleration, best of negative longitudinal acceleration, best of positive lateral acceleration and best of negative lateral acceleration.
(2) Top N. This analytic type selects the maximum N occurrences of a data or math channel. For example top 5 maximum speed events for the speed channel. The Top N analytic type returns a maximum of N scenes but it may be less depending on the data available.
(3) Bottom N. Similar to Top N this analytic type searches for the minimum N occurrences of a data or math channel. For example the bottom 5 speed events for the speed channel. The Bottom N analytic type returns a maximum of N scenes but it may be less depending on the data available.
(4) N Average. Similar to Top N this analytic type searches for the closest N occurrences to the average value of a data or math channel. For example the 5 speed events that is closest to the averaged speed value from the speed channel. The N Average analytic type returns a maximum of N scenes but it may be less depending on the data available.
(5) Threshold N. This analytic type searches for a maximum of N occurrences that cross a specific threshold within a data or math channel. The crossing of the threshold may be either above the threshold or below the threshold depending on the analytic. The threshold may also include a hysteresis function to improve scene selection. For example in motorsport this may be 5 scenes in which the braking acceleration (negative longitudinal acceleration) exceeds the threshold of 1G. The Threshold N analytic type returns a maximum of N scenes but it may be less depending on the data available.
(6) Range N. This analytic type searches for occurrences within a math or data channel that are contained within a data range. For example in motorsport this may be 5 scenes in which the Throttle Position data ranges from 10% to 90%.
(7) Combination. Each analytic type described above may be combined such that scenes are selected based upon a combination of events contained within data or math channels. For example in motorsport a scene may only be selected if the longitudinal acceleration is negative (crosses a threshold of 0) and for the Top N occurrences of throttle position.

A pseudo code example of a Best Of analytic is provided below. This analytic could equally be used for speed, longitudinal acceleration, lateral acceleration, altitude, temperature or any other data or math channel.

```
Function Find Best Of Value:
  Inputs: data channel
  Maximum value = 0
  Time of maximum value = Not set
  For each sample within the data loop
    If the data sample value is greater than the maximum value then
      Maximum value equals the data sample value
      Time of maximum value equals time of data sample
    End if
  End loop
  Return maximum value and time of maximum value
End function
```

In this manner, it is possible to identify locations in one or more recorded video streams at which sensor data acquired when the video streams were acquired corresponds to the one or more video editing parameters.

Record the Start and End Time of the Scene Corresponding to the Event (Block 534).

Once the analytic has determined the time position of an event of interest within the data the scene start time and end time is determined. As per the video editing parameters this may either be a time determined value or a data determined value. In the simplest example the video start time is N seconds prior to the event and M seconds after the event, where N and M are positive rational numbers.

Processing of the module then returns to block 528.

Sort the Analytic Results by Priority (Block 532).

In this embodiment the analytic results are sorted by priority once all analytics have been processed. This step is used to increase the quality of the video output however is not necessary in other embodiments.

Priority sorting is performed to rank analytic results between each other in order to create a video output with a hierarchy of scenes. Sorting may be performed by analytic display priority as determined in the video editing parameters, data value or by time occurrence.

In the case that data values or time is used to perform the sort operation the sorting may be performed with ascending importance by event value, descending importance by event value, random importance, first occurrence importance, last occurrence importance or some other method. As a result of sorting the video scenes may or may not appear in the order of which they occurred.

Discard Results that are not Required as Determined by the Video Editing Parameters (Block 536).

In this embodiment the sorted analytic results may be further filtered by discarding excess events (block 536). This step is used to increase the quality of the video output however is not necessary in other embodiments.

The video editing parameters may describe a maximum desired time duration of the highlights video or a maximum number of results to be shown to the user. If the total duration from the scenes described by the analytic results exceeds these parameters then the least important results are culled from the results list.

Video Selector (Block 537).

The video selector module is required in embodiments where more than one video file is available to create a scene (block 537).

Video Selection Algorithm (Block 537)

The number of video files is known. A selection algorithm uses techniques known in the art to select one. For example a pseudo random algorithm may be used in which the video file is chosen as a result of a software random number generator. Alternatively the selection may use a pre-determined sharing scheme that may be priority based. Or another method not described in this embodiment may be to choose parts of video files to create the scene.

In the event that a single video file is available the selection algorithm will always choose that single file, however where multiple video files are available the selection may be from more than one video file.

Upon selection of the video file the time of the video file is correlated to the scene time. If the video file recording time does not encapsulate the scene time then a new scene is selected until one that does is selected.

When a scene is selected the analytic result data is updated to describe which video file is to be used for each scene.

In this embodiment one video file is selected for each scene described by an analytic result. In yet other embodiments the scene may be created from multiple video files.

Video Editor (Blocks 538-544).

The video editor module edits the video to create the highlights video (blocks 538-544).

In this embodiment each scene is extracted in turn and then the highlights video is combined. In other embodiments the highlights video may be created or built up with the extraction of each scene.

In this manner an edited video stream is assembled with portions of the one or more recorded video streams. Each of the portions of the recorded video streams is thus selected based on the portions including the locations identified based on the corresponding sensor data.

Have all Analytic Results been Processed (Block 538)?

From the results of block 536 the video editor module determines if all the results have been processed. Upon first entry of this module the typical result of this test will be that there are results remaining to be used. If this is the case then processing continues to block 540.

When all results have been processed the software continues to block 542.

Copy the Video Scene Described by the Analytic Result (Block 540).

For the result being processed the module determines the scene start time and scene end time within the video and extracts that portion of the video from the original video. The scene is then saved and its location returned to the video editor module.

Combine Each Scene to Create a Summarized Video (Block 542).

Once each scene has been extracted the scenes are combined in the same order as the results. The combination may or may not include transitions between scenes, overlapping scenes, overlays onto scenes such as information or effects, audio overlays, audio mixing, audio manipulation or other visual and audio manipulation known in the art.

Save the Summarized Video (Block 544).

The resulting highlights video created in block 542 is saved to memory 205 or storage 210 as a new video.

Output (Block 546).

The output of the software program is a highlights video created from the original video content (block 546).

Summarized Video not Created (Block 548).

This module is executed by the software program in the event that the highlights video is not created. Examples of this event occurring is described in connection with the input check (blocks 508-512). In this embodiment this module may provide a message to the user and then proceed to the exit the software program. However in other embodiments this module may provide the user the option to continue or use an alternative execution path.

Finish (Block 550).

When computer 200 has finished the steps in blocks 500-548, its algorithm stops and waits at block 550. At this time, computer 200 can be deactivated or software 215 can be restarted at block 500.

### Second Exemplary Embodiment

In yet another exemplary embodiment, the first exemplary embodiment that operates on a generic activity can be readily altered to operate on a specific activity. In this embodiment the video editing parameters described in block 506 and the analytics described in block 526 are specific to the activity for which the highlights video will be created and described prior to the use of the system. For example a software product intended for use with the specific activity may be provided to the user(s) with these configurations and analytics set.

In this embodiment the user(s) do not need to provide any input as the specific and as a result the video editing processes can be completely automated with no requirement for manual selection or intervention.

In this manner, stored instructions are executed for determining from which of the video files the portions of the recorded video streams are assembled.

### Third Exemplary Embodiment

In yet another embodiment the time to receive video files across link 220 is reduced through the use of pulsed video recording.

High quality video files require significant amounts of memory for storage and subsequently for transmission. The state of the art is such that transmitting large video file(s) across link 220 is time consuming, especially so for low bandwidth links, and may impact the user experience depending on the use case of the system and desired characteristics.

Also in the general case it is not possible to predict when an event of interest will occur ahead of time so the current state of the art is to ensure all events of interest are captured is to require the camera(s) to continuously record, creating the large video files.

In this embodiment the camera(s) recording time duty cycle is changed to produce smaller video files (i.e. substreams). In the First Embodiment the camera(s) record function may be turned on at the start of an event or any time after as controlled by one or more sensors, timers or users. In this embodiment the camera record function may be configured to turn off and back on any number of times after the initial turn on time.

In one example using a single camera the camera may be configured to stop recording and start recording again with a duty cycle of 100% (that is to say the camera begins recording a new file immediately after it stops recording the previous file). In another example, within which multiple camera(s) are used, the recording duty cycle for each camera may be reduced such that each camera only records a proportion of the total scene(s) however when all videos are combined a meaningful amount of the entire scene, or the entire scene, is captured.

The duty cycle and period for each camera may be controlled by one or more sensors or alternatively by a timer function. The period may range from seconds to hours and the duty cycle may vary from 100% to near 0%.

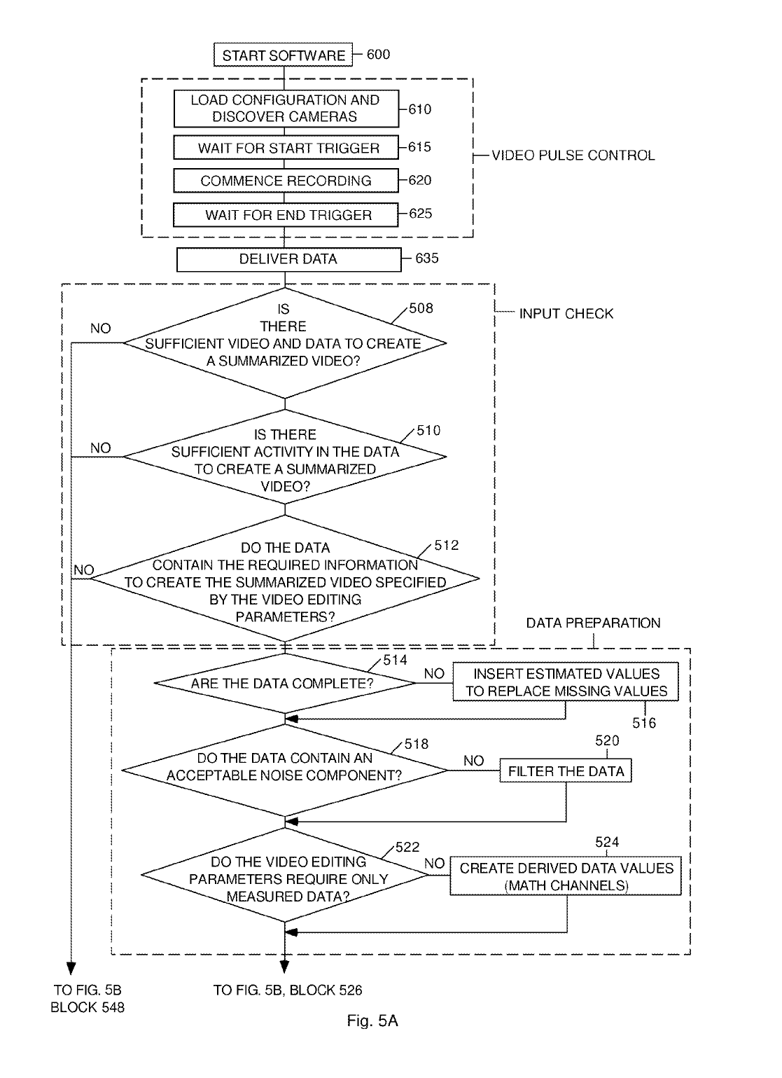

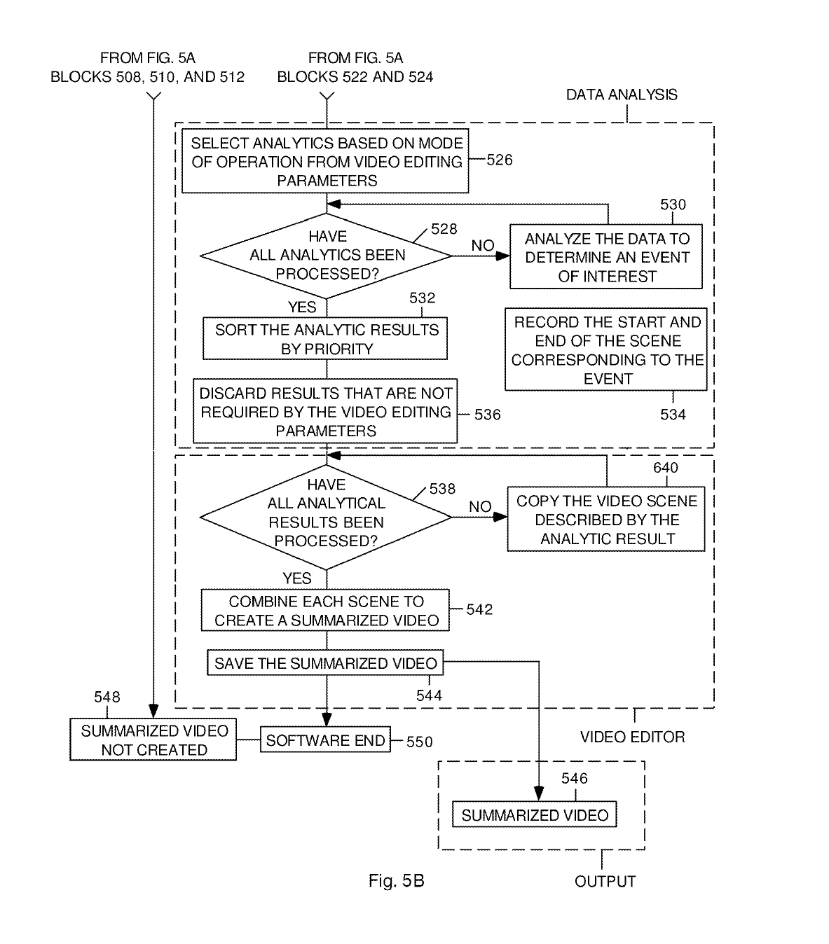

In these manifestations a database is kept that describes the camera identifier, the record start time and record duration for each camera. This database may be stored on computer 200 or otherwise transmitted from the camera(s) or sensor(s) as part of the data collection process step described in block 635. The software uses this information to reconstruct the highlights scenes as described by the flowchart of FIG. 5.

### Flowchart—FIG. 5

Video Pulse Control (Blocks 600-635).

The video pulse control module is used to control the camera(s) record duty cycles. In this embodiment the software 215 combines the control of the camera functions and the video editing functions. In other embodiments these two components may be different software programs.

In this embodiment the duty cycle for each camera is controlled centrally by the software 215 on the computer 200. In other embodiments the duty cycle may be controlled by the camera, a sensor or another device either local to the camera or on the network.

Start Software (Block 600)

At the start (block 600) software 215 is activated in computer 200.

Load Configuration and Discover Cameras (Block 610)

The module loads the list of cameras and configuration parameters for the record cycle. This includes the recording period and the duty cycle. In other embodiments this may include the camera identifier with unique settings for each camera.

With the configuration loaded the software performs a network discovery function common within the state of the art to determine which cameras are connected to the network.

Having ascertained the camera duty cycles and which cameras are connected to the network the module determines when each camera will be recording and not recording such that sufficient coverage of the scene is achieved. In this embodiment the duty cycle is calculated to ensure complete coverage and the configured period is used without evaluation. An algorithm to calculate the duty cycle is described as an example.

If the configured duty cycle for all cameras combined is greater than 100% then the configured duty cycle is used. If it is less than 100% then the configured duty cycle is replaced with the minimum duty cycle calculated by dividing 100% by the number of cameras where each camera is provided an equal duty cycle.

With the camera, duty cycle and period known the camera record and stop record commands are then scheduled by evenly spacing the camera record start times within the configured period. In the art it is well known how to do this using processing threads such that the command for each camera can be provided independent to the other and at the correct time.

In other embodiments the camera positioning may also be used in calculating the duty cycle. For example if two cameras are used but record different and distinct locations then a different duty cycle will be required to ensure adequate coverage of the scene.

Wait for Start Trigger (Block 615)

The module waits for the start trigger. The trigger may be received from the computer after a user initiated event or after a sensor or timer event has triggered the start. If a trigger is not received the module continues to wait in block 615.

Commence Recording (Block 620)

The module commences the scheduled start record and stop record processing and sends the appropriate signal to the appropriate camera. Each time a camera's record function is successfully started and stopped the module records the camera name, record start time and recording duration to a database. In this embodiment the module requests the file name stored by the camera and includes this information in the record. In other embodiments the camera file name may be calculated from timestamps or other information.

Wait for End Trigger (Block 625)

The module waits for the end trigger. The trigger may be received from the computer after a user initiated event or after a sensor or timer event has triggered the end. If a trigger is not received the module continues to wait in block 625.

Video Inputs (Block 635).

The sensor data is delivered to computer 200 in the same manner as described in block 502 in FIG. 4 of the first embodiment. The difference is the video data is not delivered at the same time.

Because the video file name is known and the time is recorded there is no need to perform the synchronization step as described by block 504 in FIG. 4 of the first embodiment.

Input Check, Data Preparation and Data Analysis (Blocks 508 to 536).

The video processing in this embodiment is the same as the FIG. 4 of the first embodiment for the input check, data preparation and data analysis. That is to say block 508 to block 536 is the same processing and described in the first embodiment.

The video selector algorithm shown in block 537 is not used in this embodiment.

Video Editor (Blocks 538 to 544 Excluding 540 and Block 640).

The video editor function differs from FIG. 4 of the first embodiment in that the video file used to create the scene is downloaded at this stage of the processing. Blocks 538 to 544 excluding block 540 function the same as per the first embodiment. Block 540 is replaced with block 640.

Copy the Video Scene Described by the Analytic Result (Block 640).

For the result being processed the module determines the scene start time and scene end time and uses the database recording that described which camera was recording at the time of the scene to determine which video files need to be retrieved from the camera(s).

The video file selection is chosen such that complete coverage of the scene from start to end time is achieved. In the event that multiple video files are required to achieve coverage the scenes are combined using transitions well known in the art. In this embodiment there is no overlap in scenes from different video files however this can occur in other embodiments and this would require a video file selection algorithm similar to the video selector algorithm of FIG. 4 block 537 described in the first embodiment.

With video file selection complete the video file is downloaded from the camera across link 220 in a process similar to that described in block 502 of FIG. 4 in the first embodiment but for video files only as the required data has already been received. Due to the video pulsing technology the video file is much smaller and the download time is less.

With the video file(s) now on the computer the scene start time and scene end time within the video is extracted from the video file(s). The scene is then saved and its location returned to the video editor module.

In this embodiment handling of the error event that the camera storing the video is not available is not described. In other embodiments the error event may result in omission of the scene or the termination of the software.

Thus, there are substreams of video data that are discontinuous streams of video over time and the locations in the video streams that correspond to the sensor data that are located by the video editing parameters correspond to respective locations in the discontinuous streams of video.

Software End and Video Output (Blocks 546, 548 and 550).

Blocks 546, 548 and 550 function the same as per FIG. 4 of the first embodiment.

### Fourth Exemplary Embodiment

In a fourth embodiment, the video pulse control function of the third embodiment is extended to control the on and off time of camera(s) and/or sensor(s) using an algorithm similar to that which can be used for video pulsing. The benefit of this embodiment includes reducing the on time of non required devices and therefore saving battery life to extend the useful of the device before requiring a battery recharge or alternative power source.

Accordingly, the reader will see that the automated video editing software of the various embodiments can be used to create a summarized video from one or multiple videos, capturing content the user(s) may like to view and disregarding content in which the user(s) may have no interest.

Activities to which the various embodiments can be applied include any sports, leisure, entertainment, educational, health, work or investigative activities, etc. Benefits include users not needing to spend time editing videos, a video with more interesting content increasing viewer engagement, a reduction in bandwidth required to share a video, a reduction in the time required to share a video and a reduction in storage space to store a video.

While the description above contains many specificities, these should not be construed as limitations on the scope of the embodiments, but rather as providing illustrations of some of several embodiment. Many other variations are possible. For example, the computer used to process the video(s) may have a monitor, multiple monitors or no monitor, etc.; the video(s) and the summarized video may be viewed locally, remotely or both, etc.; the processing of the video(s) may take place remotely, locally or in parts thereof, etc.; the processing of the video(s) may occur in real time, immediately after the event(s) or some time in the future, etc.; the video(s) and/or the data may be uploaded to other hosts, etc.; the summarized video may contain video inputs from multiple or a single videos, etc.; the same video(s) and data may be processed using different analytics to create a different summarized video, etc.; any type of sensor(s) may be used to collect data to process the video(s), including position, speed, acceleration, vibrations, altitude, pressure, orientation, heading, human or animal behaviors or characteristics (such as heart rate, blink rate, gait, fingerprint, etc.), weight, sounds, temperature, electromagnetic radiation, revolutions or oscillations, etc.; the sampling rate of the sensor(s) used may be periodic or aperiodic with a sampling period set to different values for different applications; the camera(s) and sensor(s) may be activated simultaneously or at varying times; the data collected by the sensor(s) may be recorded independent of the scene, such that data relates to events different from those recorded; the user(s) may select a mode to trigger specific analytics or the user may provide no input allowing the software to select a mode automatically through analysis of the data and data types; analytics of varying complexity ranging may be used including finding events of interest by determination of single events within a single data and/or math channel, determination of multiple events within the data or determination of multiple events from multiple data and/or math channels, etc.; graphics, text, images, overlays, filters, effects, sounds and the like may be added to the summarized video, etc.

### REFERENCE NUMERALS

100 Camera
101 Storage
105 Vehicle
110 Roadway
115 Scene
120 Camera
121 Storage
122 Record button
125 Tripod
130 Scene
135 Sensor
140 Sensor
145 Link
200 Computer
201 Monitor
205 Memory
210 Storage
215 Software
220 Link
400-405 Mode selection
500-550 Blocks
600-640 Blocks

1. A method of editing one or more recorded video streams, said method comprising the steps of:
a. receiving one or more video editing parameters;
b. identifying locations in said one or more recorded video streams at which sensor data acquired when said video streams were acquired corresponds to said one or more video editing parameters; and
c. assembling an edited video stream with portions of said one or more recorded video streams, wherein each of said portions is selected based on said portions including said identified locations.

2. A method according to claim 1, further comprising the steps of:
a. acquiring said video streams from one or more cameras; and
b. acquiring said sensor data from one or more sensors while said video streams are being acquired.

3. A method according to claim 2, wherein said sensor data is one or more physical parameters obtained by one or more sensors, and said one or more video editing parameters are numerical values achieved by said one or more physical parameters.

4. A method according to claim 1, wherein said one or more physical parameters is speed of an object.

5. A method according to claim 1, wherein said sensor data is stored in one or more data streams that correspond to said one or more video streams.

6. A method according to claim 1, wherein one of said portions includes
a. one of said identified locations in one of said video streams;
b. a pre-time period in said one of said video streams prior to said identified location; and
c. a post-time period in said one of said video streams after said identified location.

7. A method according to claim 2, wherein said video streams and said sensor data are acquired separately.

8. A method according to claim 1, wherein multiple types of sensor data are used to determine if one of said locations corresponds to one of said video editing parameters.

9. A method according to claim 1, wherein said one more recorded video streams are obtained from a plurality of video files, said method further comprising the step of executing stored instructions for determining from which of said plurality of video files said portions of said one or more recorded video streams are assembled.

10. A method according to claim 1, wherein at least one of said video streams acquired includes a plurality of substreams of video data that are discontinuous streams of video over time and said locations correspond to respective locations in said discontinuous streams of video over time.

11. An apparatus for editing one or more recorded video streams, said apparatus comprising:
a. video editing parameter storage for receiving one or more video editing parameters;
b. processor enabled location identifier for identifying locations in said one or more recorded video streams at which sensor data acquired when said video streams were acquired corresponds to said one or more video editing parameters; and
c. a video stream assembly engine for assembling an edited video stream with portions of said one or more recorded video streams, wherein each of said portions is selected based on said portions including said identified locations.

12. An apparatus according to claim 11, wherein said video streams are acquired from one or more cameras; and said sensor data is acquired from one or more sensors while said video streams are being acquired.

13. An apparatus according to claim 12, wherein said sensor data is one or more physical parameters obtained by one or more sensors, and said one or more video editing parameters are numerical values achieved by said one or more physical parameters.

14. An apparatus according to claim 11, wherein said one or more physical parameters is speed of an object.

15. An apparatus according to claim 11, wherein said sensor data is stored in one or more data streams that correspond to said one or more video streams.

16. An apparatus according to claim 11, wherein one of said portions includes
a. one of said identified locations in one of said video streams;
b. a pre-time period in said one of said video streams prior to said identified location; and
c. a post-time period in said one of said video streams after said identified location.

17. An apparatus according to claim 12, wherein said video streams and said sensor data are acquired separately.

18. An apparatus according to claim 11, wherein multiple types of sensor data are used to determine if one of said locations corresponds to one of said video editing parameters.

19. An apparatus according to claim 11, wherein said one more recorded video streams are obtained from a plurality of video files, and wherein stored instructions are executed for determining from which of said plurality of video files said portions of said one or more recorded video streams are assembled.

20. An apparatus according to claim 11, wherein at least one of said video streams acquired includes a plurality of substreams of video data that are discontinuous streams of video over time and said locations correspond to respective locations in said discontinuous streams of video over time.
